(19) United States
(12) Patent Application Publication
(10) Pub. No.: US 2003/0110904 A1
(43) Pub. Date: Jun. 19, 2003

(54) Adjustable wrench structure with a multiple-thread worm

(76) Inventor: Jin-Fu Chen, Ta-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/357,199

(22) Filed: Feb. 4, 2003

Related U.S. Application Data
(63) Continuation-in-part of application No. 09/985,703, filed on Nov. 6, 2001.

(51) Int. Cl. B25B 13/16

(52) U.S. Cl. 81/165

(57) ABSTRACT

A wrench structure with a multiple-thread worm includes a main body having a handle extending from the main body. A fixed jaw projects from one end of the main body opposite to the handle. The main body is formed with a slide channel and a movable is partially received in the channel and moved corresponding to the fixed jaw. The movable jaw has a rack extending therefrom and slidably received in the channel. A receiving hole is defined in the main body and communicating with the channel. The multiple-thread worm is rotatably received in the receiving hole and engaged to the rack of the movable jaw. The multiple-thread worm has multiple parallel spirals spaces from each other.

### CROSS-REFERENCE TO RELATED APPLICATION

The application is a Continuation-In-Part of Ser. No. 09/985,703, filed Nov. 6, 2001, and entitled “WRENCH STRUCTURE”, now pending.

### BACKGROUND OF THE INVENTION

1. Field of the Invention

The present invention relates to an adjustable wrench structure, and more particularly to an adjustable wrench structure with a multiple-thread worm.

2. Description of Related Art

A first conventional adjustable wrench structure in accordance with the prior art shown in FIGS. 8 and 9 comprises a main body (8) having a handle (81) extending from the body (8). The main body (8) has a fixed jaw (82) extending from the main body (8) opposite to the handle (81) and an adjustment hole (83) defined in the body (8) and laterally extending through the main body (8). A worm (84) is rotatably received in the adjustment hole (83). A spring (841) is compressively mounted between a top of the worm (84) and the wall of the adjustment hole (83) to hold the worm (84) in place. A channel (87) is laterally defined in the main body (8). The slide channel (87) upwardly extends to an outer periphery of the main body (8) and communicates with the adjustment hole (83). A movable jaw (85) is slidably mounted on the main body (8) and corresponds to the fixed jaw (82). A rack (86) is formed and extends from a bottom the rack (86). The rack (86) is movably received in the slide channel (87) and engaged to the worm (84).

It is hard to increase the length of the worm (84) due to the main body (8) and the adjustment hole (83). In order to increase the number of the teeth of the worm (84) meshing with the rack (86) to achieve an enlarged frictional face, the worm (84) is generally designed as a single-thread worm that is easy to process and has a shorter pitch as shown in FIG. 10. Accordingly, the number of the teeth of the worm (84) and the rack (86) is increased to provide sufficient supporting force for the movable jaw (85). However, the shorter pitch (P) of the worm (84) makes if time-consuming to turn the worm (84) for adjusting the position of the movable jaw (85). Consequently, the movable jaw (85) is hard to be quickly adjusted to tightly clamp and tighten or loosen a work piece.

In order to quickly adjust the movable jaw (85) to clamp the work piece for tightening or loosening the work piece, the pitch of the worm (84) is enlarged into (P1) as shown in FIG. 11. However, under such circumstance, the number of the teeth of the enlarged worm (84) and the rack (86) are reduces so that the worm (84) is unable to provide sufficient supporting force for the movable jaw (85).

With reference to FIGS. 12 and 13 that show a second embodiment of the conventional adjustable wrench. The conventional adjustable wrench can be quickly adjusted. The bottom end of the worm (91) is formed with a toothed section (911). In addition, two pulleys (94, 95) drivingly engaged with a toothed belt (93) are disposed in the handle (92). The pulley (94) is connected with a gear (96) that is engaged with the toothed section (911) of the worm (91). By means of pushing a push button (931) connected with the toothed belt (93), the toothed belt (93) is moved to make the gear (96) drive and quickly rotate the worm (91). Consequently, the position of the movable jaw (97) can be quickly adjusted to tightly clamp and tighten or loosen the work piece between the movable jaw (97) and the fixed jaw (98).

The worm (91) of the above adjustable wrench can be quickly rotated to adjust the position of the movable jaw (97). However, many additional components are necessary so that the structure of such wrench is quite complicated and it is difficult to be manufactured and the manufacturing cost is increased. Some other adjustable wrenches include additional ratchet mechanisms or shifting mechanisms in cooperation with the worm for quickly clamping and tightening or loosening the work piece. All these wrenches include additional components and have complicated structures and are manufactured at high cost.

With reference to FIGS. 14 and 15 that show an adjustable wrench disclosed in U.S. Pat. No. 953,346. The spiral (711) of the worm (71) of the adjustable wrench (7) is interrupted so that the worm (71) is formed with two axially extending interrupting channels (712) free form the spiral (711). The width of the interrupting channel (712) is slightly larger than that of the rack (721) of the movable jaw (72). After the worm (71) rotated to aim the interrupting channel (712) at the rack (721), the movable jaw (72) is quickly moved.

However, it is necessary to additionally process the worm (71) to form the interrupting channels (712) on the spiral (711) this makes it more difficult to manufacture the worm (71) and leads to increase manufacturing cost. Furthermore, the strength of the spiral (711) of the worm (71) is weakened such that the supporting force for the movable jaw (72) is reduced. In addition, the interrupting channels (712) cannot mesh with the rack (721) of the movable jaw (72) so that it is uneasy to adjust the position of the movable jaw (72).

Summarily, all the above conventional measures for quickly adjusting the position of the movable jaw to clamp and tighten or loosen a work piece are hard to manufacture and at a high cost of manufacturing. With respect to the wrench in which the worm is formed with interrupting channels, it is uneasy to perform the adjustment. Consequently, it is necessary to develop an adjustable wrench that has a simple structure and is easy manufactured for quickly adjusting jaw to clamp and tighten or loosen a work piece.

The present invention has arisen to mitigate and/or obviate the disadvantages of the conventional adjustable wrenches.

### SUMMARY OF THE INVENTION

It is therefore a primary objective of the present invention to provide an improved wrench structure with a multiple-thread worm for quickly moving the movable jaw. In addition, there are still many teeth of the multiple-thread worm engaged with the rack of the movable jaw to achieve large frictional area and enhance the resistance against the reaction force. The tooth thickness of the worm is increased so as to reinforce the worm. Therefore, without adding any component into the wrench, the position of the movable jaw is quickly adjusted to clamp and tighten or loosen a work piece.

It is a further objective of the present invention to provide the above wrench structure in which without adding any component into the wrench, the worm is directly made as a multiple-thread worm so that it is easier to manufacture the wrench structure.

It is still a further objective of the present invention to provide the above wrench structure with a multiple-thread worm, which includes a main body formed with a receiving hole in which the multiple-thread worm is disposed. The handle of the wrench structure extends from a main body of the wrench structure and having two flutes defined in two opposite sides of the handle and extending to the receiving hole in the main body, whereby the turning angle of the multiple-thread worm is enlarged so as to speed the adjustment of the position the movable jaw.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adjustable wrench structure with a threaded worm in accordance with the present invention.

FIG. 2 is a partially cross sectional view of the adjustable wrench structure in FIG. 1;

FIG. 3 shows the relationship between the pitch and spiral angle of the worm;

FIG. 4 is a side operational plan view of the adjustable wrench of the present invention;

FIG. 5 is a side operational plan view of a conventional adjustable wrench;

FIG. 6 is a partially plan view of the worm of the adjusting wrench in FIG. 1, wherein the worm is triple-threaded and has an adjustment L₂;

FIG. 7 is a partially plan view of the worm of the adjusting wrench in FIG. 1, wherein the worm is triple-threaded and has an adjustment L₃;

FIG. 8 is a perspective view of a first conventional adjustable wrench in accordance with the prior art;

FIG. 9 is a partially cross sectional view of the adjustable wrench in FIG. 8;

FIG. 10 is a partially plan view of a first embodiment of the worm of the adjustable wrench in FIG. 8, wherein the worm has a pitch P₁;

FIG. 11 is a partially plan view of a second embodiment of the worm of the adjustable wrench in FIG. 8, wherein the worm has a pitch P₂ that has a length longer than that of the worm in FIG. 110;

FIG. 12 is a side plan view of a second conventional adjustable wrench in accordance with the prior art;

FIG. 13 is a partially cross sectional view of the adjustable wrench in FIG. 12;

FIG. 14 is a side plan view of a third conventional adjustable wrench in accordance wit the present invention; and

FIG. 15 a partially side cross sectional view of the adjustable wrench in FIG. 14.

### DETAILED DESCRIPTION OF THE INVENTION

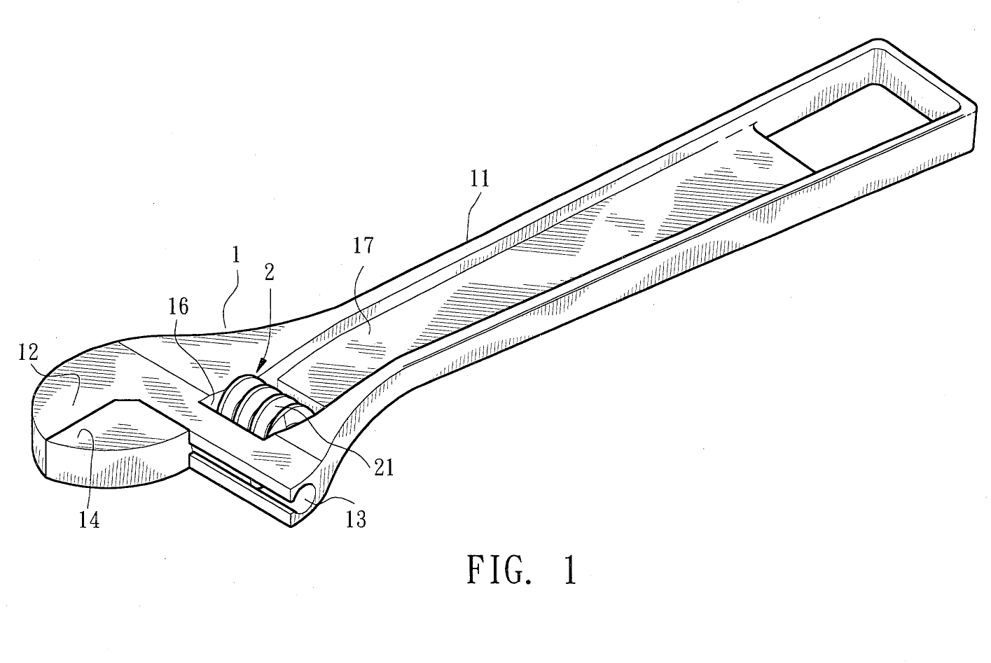

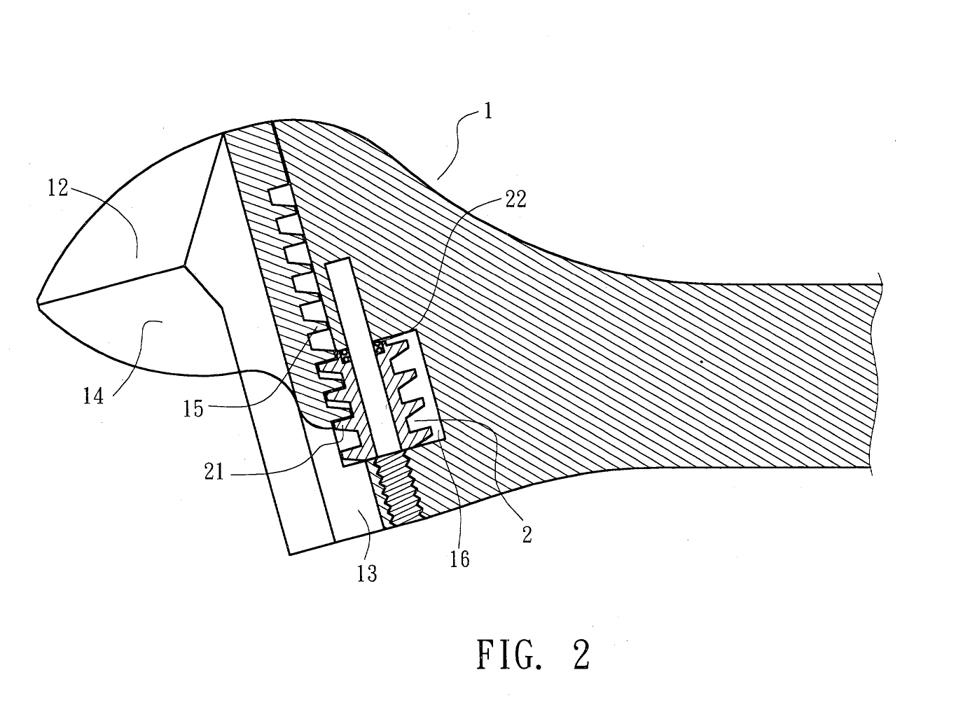

Referring to the drawings and initially to FIGS. 1 and 2, a wrench structure with a multiple-thread worm (2) in accordance with the present invention comprises a main body (1) having a handle (11) extending from the main body (1). A fixed jaw (12) projects from the main body (1) opposite to the handle (11). A movable jaw (14) is partially received in he main body (1) and slidably moved corresponding to the fixed jaw (12). A slide channel (13) is laterally defined in the main body (1) and extending to an outer periphery of the main body (1). The movable jaw (14) has a rack (15) extending from the movable jaw (14) and slidably received in the slide channel (13) in the main body (1). A receiving hole (16) is defined in the main body (1) and laterally communicates with the slide channel (13). The handle (11) has a substantially H-shaped cross-section, whereby the handle (11) includes two opposite sides each having a flute (17) defined in each side of the handle (11) and extending alone an axis of the handle (11). The flute (17) has a width approximately equal to that of the receiving hole (16) and extends to communicating with the received hole (16). The multiple-thread worm (2) is rotatably received in the receiving hole (16) and engaged to the rack (15) of the movable jaw (14).

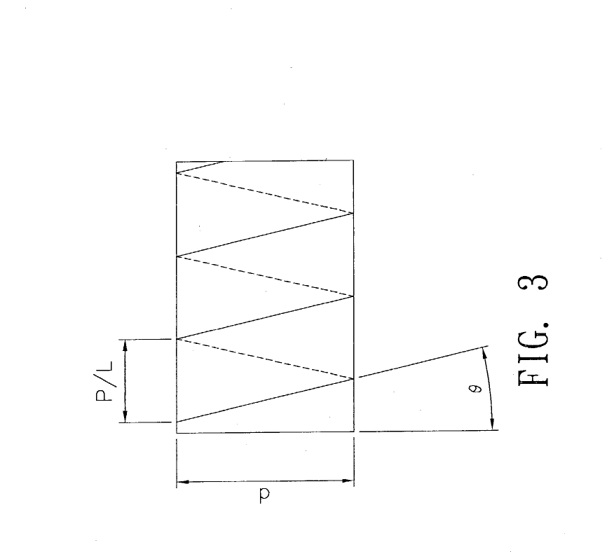

With reference to FIG. 3, a single threaded worm includes a diameter (d), a spiral angle (θ) and a pitch (P) between every two adjacent spirals such that the adjustment (L) of the movable jaw is (P) when the wrench structure used with a single threaded worm that takes a turn.

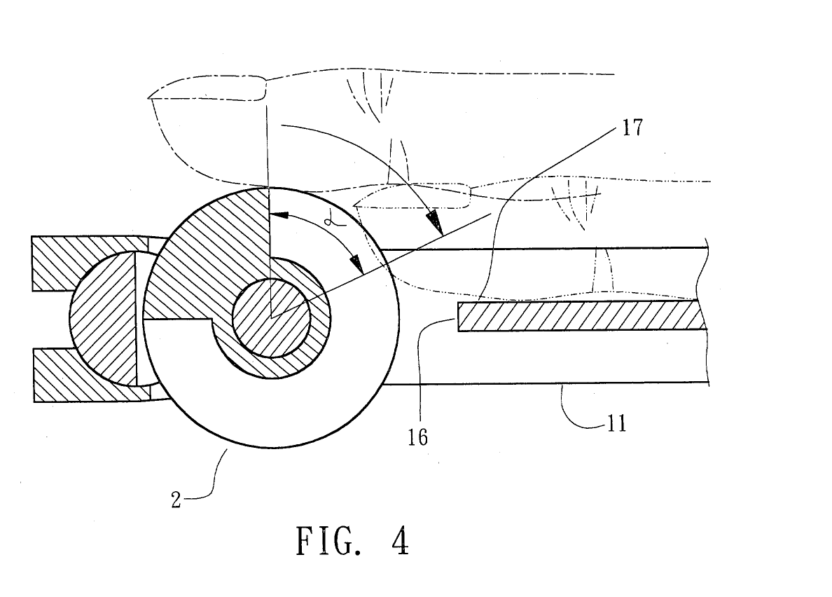

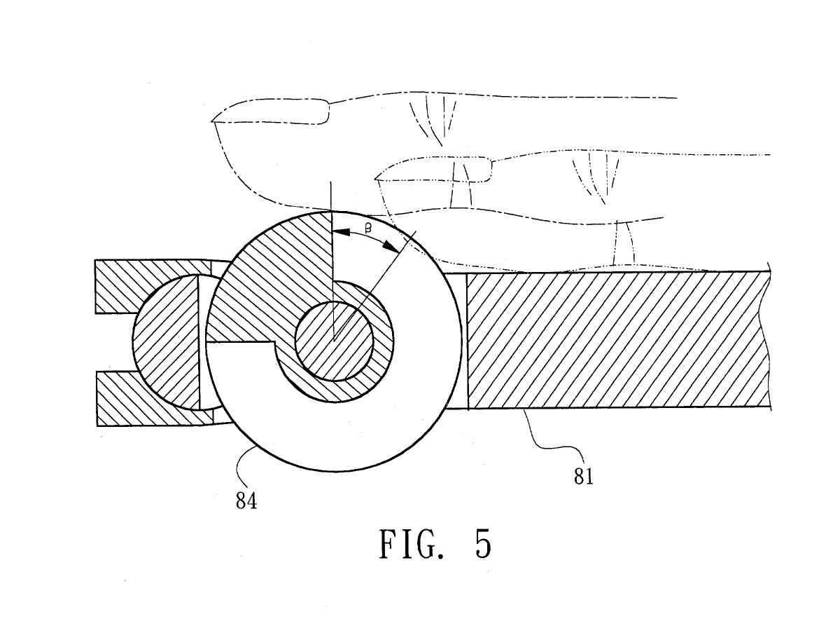

With reference to FIG. 4, when turning the worm (2), the user's finger moves into flute (17) of the handle (11) to turn the worm (2) by an angle (α) further with reference to FIG. 5 that shows a conventional wrench without and flute in the handle (81), when turning the worm (84), the user's finger only moves to abut against the handle (81) consequently, the worm (84) is turn by an angle (β). Comparison FIG. 4 with FIG. 5, it is obvious that α>β. That is, by means of the flute (17) of the handle (11), the turning angle of the worm (2) is increased so that the adjustment of the movable jaw (14) is speeded.

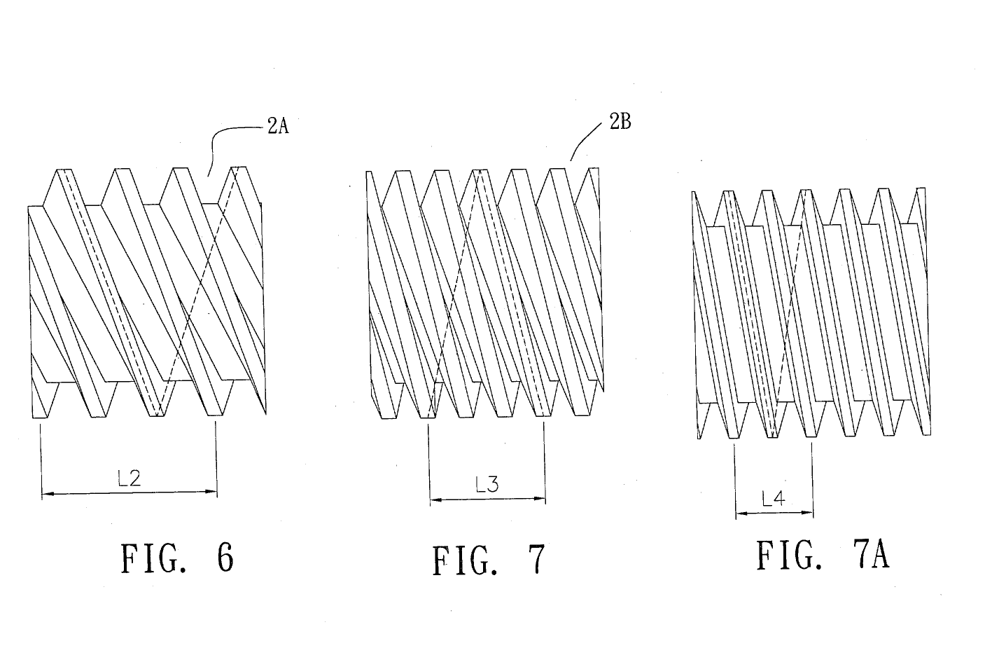

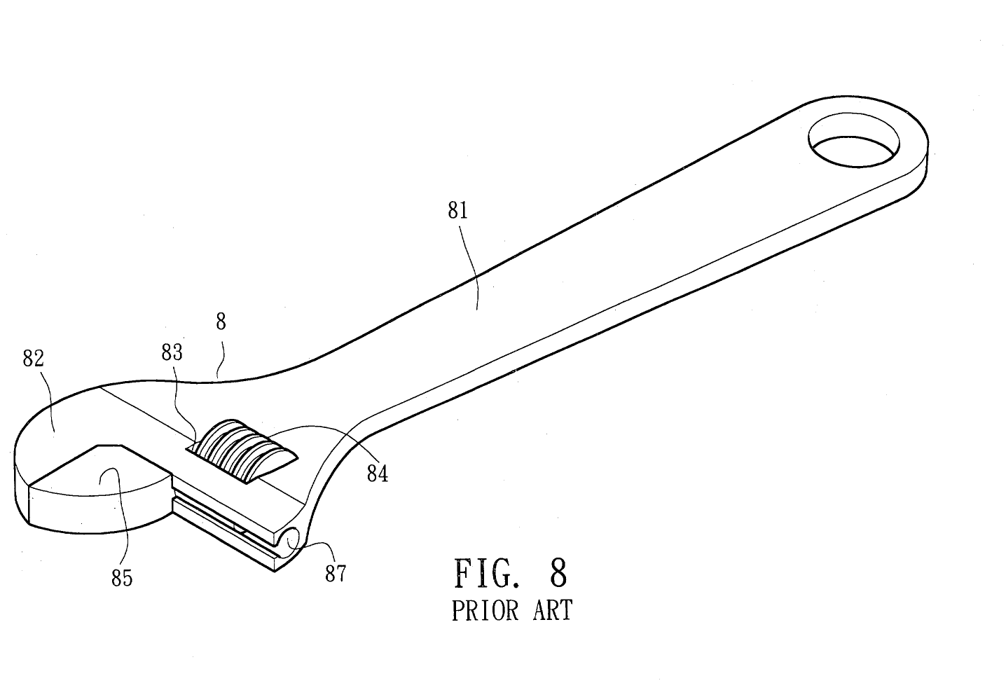

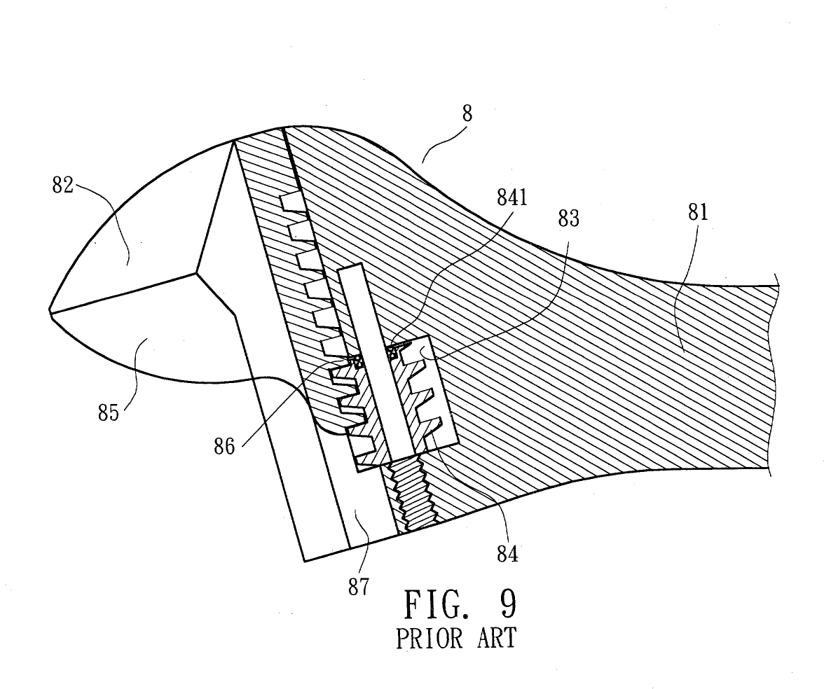

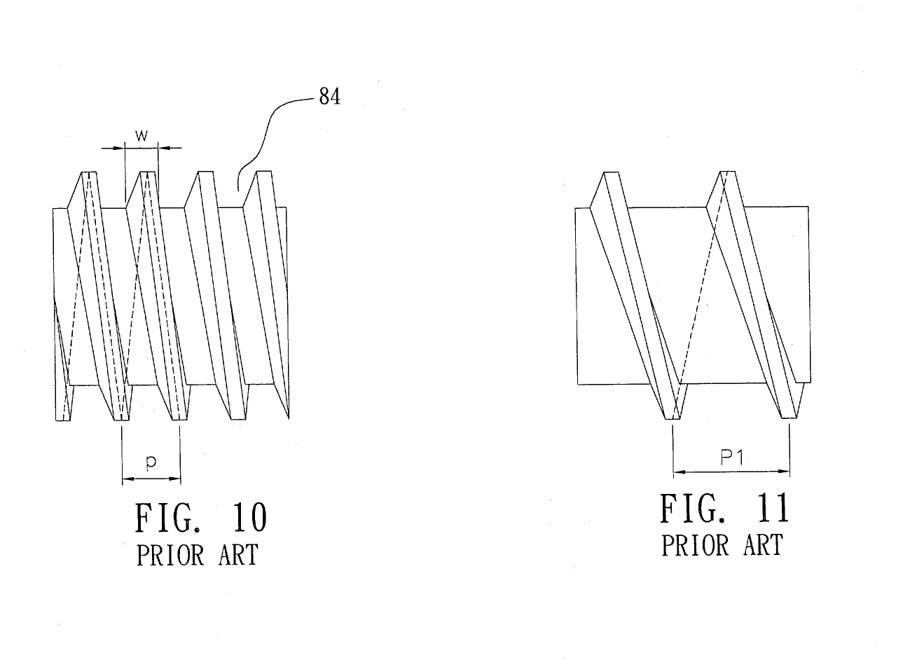

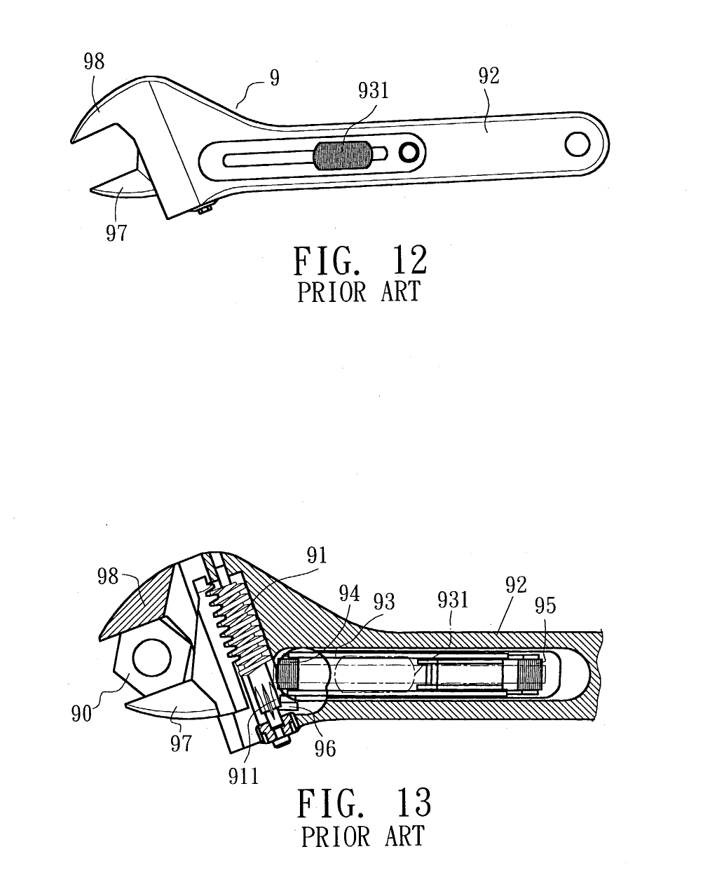

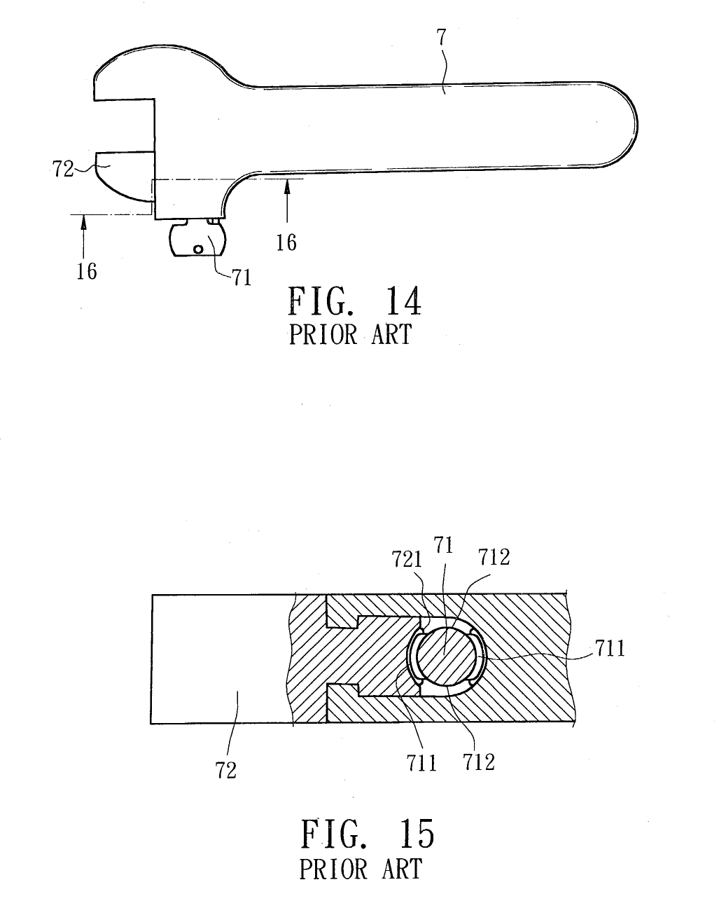

With reference to FIG. 6 that shows an embodiment of the multiple-thread worm that is a triple threaded worm and the adjustment (L2) of the triple threaded worm (2A) is three times the pitch (P) of the single threaded worm in FIG. 8 for quickly moving the movable jaw (14). However, the applicant discovers that the triple threaded worm having an adjustment three times the pitch (P) of the single threaded worm has a pitch (P) equal to the single threaded worm in FIG. 8. Consequently, except for quickly moving the movable jaw (14), the adjustable wrench has all the disadvantages of the conventional adjustable wrench such as a reversal turn may occur when the adjustable wrench bears a great torsion force.

Consequently, the worm of the present invention is a triple threaded worm as shown in FIG. 7. The adjustment (L3) of the worm (2B) has an adjustment, which is twice the pitch (P) of the single threaded worm in FIG. 10 such that the number of the teeth of the multiple-threaded worm is increased for resisting a great torsion force when the adjustable wrench is in a heavy duty. As described above, the adjustable wrench in accordance with the present invention not only can quickly move the movable jaw (14) and has a structure good enough to resist a greater torsion force.

With reference to FIG. 7A, as regard to the relationship between the (L), the pitch (P) of the single threaded worm in FIG. 10 and the number of teeth, the multiple threaded worm, as shown in FIG. 7A, is a double threaded worm and has an adjustment (L4) that has a length equal to one and one-thirds (P) of the single threaded worm in FIG. 10.

Furthermore, without adding any component into the wrench of the present invention, the multiple-thread worm in accordance with the present invention makes is easy to manufacture the wrench at a low cost. Furthermore, the multiple-thread worm elongates the adjustment (L) of the movable jaw (14) so that the position of the movable jaw (14) is quickly adjusted to clamp and tighten or loosen a work piece. In addition, there are still many teeth (21) of the worm (2) engaged with the rack (15) of the movable jaw (14) and the tooth thickness (W) of the worm (2) is increased so as to provide enhanced supporting force for the movable jaw (14).

As described above, the wrench structure with a multiple-thread worm in accordance with the present invention comprises several advantages as follow:

1. Without adding any component into the wrench and only by means of the multiple-thread worm, the adjustment (L) is increased so as to more quickly adjust the position of the movable jaw (14) for clamping and tightening or loosening a work piece.

2. There are still many teeth (21) of the multiple-thread worm (2) engaged with the rack (15) of the movable jaw (14).

3 The tooth thickness (W) of the multiple-thread worm (2) is increased so as to provide enhanced supporting force for the movable jaw (14).

As well know, the multiple-thread worm is a very conventional structure and the adjustable wrench has been invented for over one hundred years. However, an adjustable wrench with a multiple-thread worm has never seen such that the applicant is of the opinion that one skilled in the art viewing the adjustable wrench and the multiple-thread worm would not be motivated to disposed a wrench structure used with a multiple-thread worm for quickly moving the movable jaw to clamp and tighten or loosen a work piece because the diameter, the thickness of the tooth of the worm and the number of the teeth must be precisely calculated for a great torsion force during being operated.

Although the invention has been explained in relation to its preferred embodiment, it is to be understood that many other possible modifications and variations can be made without departing from the spirit and scope of the invention as hereinafter claimed.

What is claimed is:

1. A wrench structure with a multiple-thread worm, comprising a main body having a handle extending from the main body, a fixed jaw projecting from one end of the main body opposite to the handle, the main body being formed with a slide channel, a movable partially received in the channel and moved corresponding to the fixed jaw, the movable jaw having a rack extending therefrom and slidably received in the channel, a receiving hole defined in the main body and communicating with the channel, the multiple-thread worm rotatably received in the receiving hole and engaged to the rack of the movable jaw, the multiple-thread worm having multiple parallel spirals spaces from each other and being a triple-thread worm that has an adjustment twice a pitch of a single-thread worm.
